(19) United States
(12) Patent Application Publication
(10) Pub. No.: US 2025/0364874 A1
(43) Pub. Date: Nov. 27, 2025

(54) Electric Motor

(71) Applicant: Innomotics GmbH, Nürnberg (DE)

(72) Inventor: Frank Brütting, Erlangen (DE)

(73) Assignee: Innomotics GmbH, Nürnberg (DE)

(21) Appl. No.: 18/874,823

(22) PCT Filed: May 4, 2023
(86) PCT No.: PCT/EP2023/061842

§ 371 Date: Dec. 13, 2024

(30) Foreign Application Priority Data
Jun. 14, 2022 (EP) 22178976.1

(51) Int. Cl. H02K 9/22; H02K 3/50; H02K 11/33

(52) U.S. Cl. CPC H02K 9/227; H02K 3/50; H02K 11/33; H02K 2203/09; H02K 2211/03

(57) ABSTRACT

Various embodiments of the teachings herein include an electric motor comprising: a stator with a plurality of field conductors; a cooling plate; a printed circuit board arranged on the cooling plate; a plurality of power electronic components for controlling the field conductors, the power electronic components arranged on the printed circuit board; and a groove-like recess in the cooling plate. The cooling plate in is mechanical contact with the field conductors via current conductors electrically connected to the field conductors. A busbar is arranged in the groove-like recess and thereby electrically insulated from the cooling plate and at least partially covered by the printed circuit board. The printed circuit board is in electrical contact with the busbar.

### CROSS-REFERENCE TO RELATED APPLICATIONS

This application is a U.S. National Stage Application of International Application No. PCT/EP2023/061842 filed May 4, 2023, which designates the United States of America, and claims priority to EP application Ser. No. 22/178,976.1 filed Jun. 14, 2023, the contents of which are hereby incorporated by reference in their entirety.

### TECHNICAL FIELD

The present disclosure relates to electric motors. Various embodiments include an electric motor with a stator-side bar winding.

### BACKGROUND

Electric motors can have a stator-side bar winding. In this case, the stator has a series of bars instead of wound wire conductors as field conductors. The bars have a low inductance compared to conventional windings. Therefore, a comparatively high current flow is required to generate a predetermined magnetic field. A motor of this type is shown in EP19167289 A1.

However, due to the low resistance of the bars, this high current flow requires only a comparatively low voltage of, for example, 12 V. The low voltage makes it possible to arrange the components of the inverters, which are used to control the bars, at short distances from one another. This means that the components of the power electronic system can be arranged on one or more printed circuit boards (PCBs), for example, which are arranged close to the electric motor. The bars can be used directly as a mechanical support for the printed circuit boards, either directly or via electrically conductive bar-like connecting elements.

The printed circuit boards are mounted on cooling plates and contacted individually via electrical busbars. The busbars are located on the printed circuit boards and are in contact with them via screw connections. However, the screw connections are also attached to the cooling plates (mechanically decoupled from them) in order to establish a secure contact. This raises the problem of insulation between the screw connection and the cooling plate, which has to be solved for each individual screw connection by means of a corresponding sleeve. In particular, if a printed circuit board has to be replaced due to defective individual components, the two busbars that clamp and supply up to 150 printed circuit boards with power usually have to be unscrewed and then completely insulated and screwed on again.

### SUMMARY

The teachings of the present disclosure include electric motors with a stator-side bar winding and an integrated power electronic system that requires less repair effort than the prior art when replacing printed circuit boards of the power electronics. For example, some embodiments include an electric motor (10) with: a stator (11) with a plurality of field conductors (12) in the form of bars, a plurality of power electronic components for controlling the field conductors (12), wherein the power electronic components are arranged on one or more printed circuit boards (15), at least one printed circuit board (15) is arranged on at least one cooling plate (16), the cooling plate (16) is arranged such that the field conductors (12) are in mechanical operative contact with the cooling plate via current conductors (18) that are electrically connected to the field conductors (12), wherein at least one groove-like recess (20) is provided in the cooling plate (16) and at least one busbar (22) is arranged in said groove-like recess so as to be electrically insulated from the cooling plate (16), and is thereby at least partially covered by the printed circuit boards (15), and the printed circuit boards (15) are in electrical contact with the at least one busbar (22).

In some embodiments, at least two busbars (22) are arranged in the recess (20).

In some embodiments, two busbars (22) are arranged next to each other in the recess radially with respect to a motor axis (9).

In some embodiments, two busbars (22) are arranged one above the other in the recess along the motor axis (9).

In some embodiments, at least two recesses are provided, each with at least one busbar.

In some embodiments, the cooling plate is designed as a second busbar.

In some embodiments, the cooling plate is ring-shaped.

In some embodiments, the busbar is ring-shaped.

In some embodiments, the busbar is clamped in the recess by means of an insulating flexible material.

In some embodiments, the printed circuit boards (15) are electrically contacted with the at least one busbar (22) by means of a screw connection.

In some embodiments, the printed circuit boards (15) are designed in the shape of a circle or a ring sector.

In some embodiments, the cooling plate (16) is arranged perpendicular with respect to the axis (9) of the electric motor (10).

In some embodiments, the electric motor (10) controls each of the field conductors (12) with a dedicated phase.

In some embodiments, the inverters are designed so as to generate an alternating voltage with an amplitude of 200 V or less, in particular 150 V or less, in particular 50 V or less.

### BRIEF DESCRIPTION OF DRAWINGS

Further embodiments of the teachings herein and further features will be explained in more detail in the following figures. These are purely schematic embodiments and do not constitute a limitation of the scope of protection. In the drawings:

FIG. 1 shows a side view of an electric motor with cooling plates for dissipating heat from printed circuit boards incorporating teachings of the present disclosure;

FIG. 2 shows a front view of the electric motor;

FIG. 3 shows an enlarged representation of FIG. 1 in the section of the cooling plates in a side view with busbars;

FIG. 4 shows the same section as in FIG. 3 with a modified arrangement of the busbars;

FIG. 5 shows a cross-section through a cooling plate with printed circuit boards and busbars recessed in two groove-like recesses incorporating teachings of the present disclosure;

FIG. 6 shows a cross-section as in FIG. 5 with busbars arranged one above the other in a recess;

FIG. 7 shows a cross-section as in FIG. 5 and FIG. 6 with a single recess and two busbars arranged therein; and

FIG. 8 shows a partial cross-section through a cooling plate that schematically shows a screw connection between a busbar and a circuit board incorporating teachings of the present disclosure.

### DETAILED DESCRIPTION

Some embodiments of the teachings herein include electric motor comprises a stator with a plurality of field conductors in the form of bars, a plurality of power electronic components for controlling the field conductors, wherein the power electronic components are arranged on one or more printed circuit boards, and at least one printed circuit board that is arranged on at least one cooling plate, wherein the cooling plate is arranged such that the field conductors are in mechanical operative contact with the cooling plate via current conductors that are electrically connected to the field conductors. The current conductors thus form current-conducting connecting elements between the field conductors and the printed circuit boards and ultimately to the power electronic components (including semiconductor switches). Due to the mechanical operative connection, these also have a load-bearing function for the cooling plate, although they are electrically insulated from it, wherein at least one groove-like recess is provided in the cooling plate and at least one busbar is arranged in said groove-like recess so as to be electrically insulated from the cooling plate, and is thereby at least partially covered by the printed circuit boards, and the printed circuit boards are in electrical contact with the at least one busbar.

The electric motors described herein differ from conventional electric motors in that the stator has a series of bars instead of wound wire conductors as field conductors. The bars have a low inductance compared to conventional windings. Therefore, a comparatively high current flow is required to generate a predetermined magnetic field.

The design of the bar winding results in potential advantages for the operation the of machine: The segment-by-segment controllability of the magnetic flux between two field conductors allows far more flexible magnetic field shapes to be impressed into the machine than would be possible with a distributed winding and its inherent superimposition effects. This results in many (closed-loop control-related) advantages with regard to the running properties of the machine. Furthermore, the failure of one phase (of the control of a field conductor) has far less impact than it would, for example, on a double-three-phase or even a normal three-phase machine. Since these effects can be very well compensated by the neighboring phases, the drive power is almost the only thing that drops with each phase failure, by only a small fraction, with appropriate regulation, without significantly affecting the other properties.

The electric motor described herein has busbars not arranged on the printed circuit boards, but are recessed in the cooling plate. In this manner, each printed circuit board can be removed and replaced individually with little effort by loosening the screw connection, which usually also provides the contact with the busbars. This means that it is not necessary to disassemble large parts or even the entire structure of all circuit boards for a repair, which means a considerable reduction in the amount of work involved in repair work on the power electronic system and thus represents a cost advantage. The repair costs are significantly reduced.

Furthermore, this makes it technically easier to provide insulation between the cooling plate and the busbar, since the contact is only made between the printed circuit board and the busbar. The busbar itself can be insulated from the cooling plate using conventional insulating material. The conventional screw connection with the cooling plate can be omitted if necessary, which means a further reduction in assembly work.

In some embodiments, two busbars are arranged in the recess. In this way the area of the groove-shaped recess, which is not constructively available for dissipating heat from the printed circuit board, can be reduced. Two busbars can be arranged next to each other in the recess radially with respect to a motor axis. This makes it possible to guide two busbars in one recess with little effort for the insulation between the cooling plate and the busbars.

In some embodiments, two busbars are arranged one above the other in the recess along the motor axis, which requires a more complex contacting process but is suitable for keeping the width of the recess small and thus providing a larger area for heat dissipation. On the other hand, it may be useful to provide at least two recesses, each with at least one busbar. In this way, specific areas of the printed circuit board can be contacted in a targeted manner.

In some embodiments, the cooling plate comprises a busbar. This means that the recess takes up as little surface area of the cooling plate as possible and at least one busbar runs in it. The cooling plate, provided it is made of metal, can take on the function of the second busbar. This further reduces the assembly and disassembly effort.

It should be noted that exactly two busbars are not necessarily used for the motor described. It may be advantageous to use duplicated potentials or, for example, three potentials with an intermediate circuit center point or double (redundant) intermediate circuits, in which case more than two busbars are required. Using the cooling plate as a busbar thus eliminates the need for a busbar.

In some embodiments, the cooling plate is ring-shaped. This allows it to be integrated into the electric motor in a space-saving way. In this context, it is also expedient that the busbar is ring-shaped or ring-sector-shaped. It then runs along the contour of the cooling plate and the printed circuit boards adapted to it.

In some embodiments, the busbar may be clamped in the recess by means of an insulating flexible material. Such a flexible and insulated material can be, for example, a profiled silicone ring or also a thermally resistant and electrically insulating glass fiber fabric.

In some embodiments, the printed circuit boards are electrically contacted with the at least one busbar by means of a screw connection. The printed circuit boards can be designed in the shape of a circle or a ring sector. Printed circuit boards with this shape can be assembled into a circle or ring and thus optimally adapted to the shape of the electrical machine at one axial end of the machine, while at the same time achieving a high degree of modularity.

The terms “axial”, “radial”, and “tangential” refer to the axis of the rotor and thus to the corresponding axis of symmetry of the stator. In this context, “axial” describes a direction parallel to this axis, “radial” describes a direction orthogonal to the axis, towards or away from it, and “tangential” is a direction that is circular around the axis at a constant radial distance from the axis and at a constant axial position. The term “in the circumferential direction” is synonymous with “tangential”.

When the terms “axial”, “radial”, and “tangential” are used in relation to a surface, for example a cross-sectional surface, the terms describe the orientation of the normal vector of the surface, i.e. the vector that is perpendicular to the surface in question.

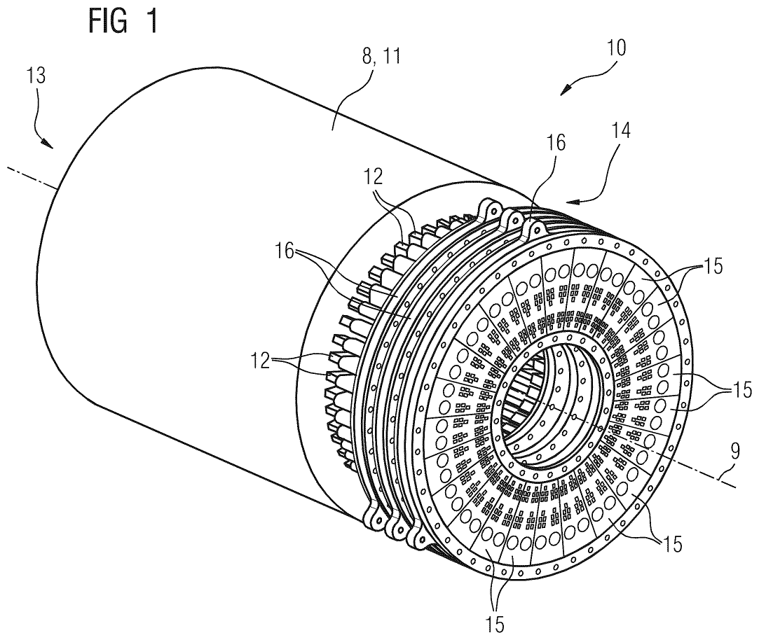

FIG. 1 is an isometric view of an electric motor 10 incorporating teachings of the present disclosure. The electric motor 10 includes a stator 11 and a rotor that is arranged substantially in the stator 11 and is not visible in FIG. 1. The rotor is connected in a rotationally fixed manner to a shaft that is also not shown in FIG. 1. The rotor is set in rotation about an axis 9 by electromagnetic interaction of the rotor with a current-carrying stator 11. The rotor is separated from the stator 11 by an air gap.

In some embodiments, the electric motor 10 can also be an external rotor motor or a bell-type armature motor.

The stator 11 comprises a plurality of rigid and straight conductor bars 12 as field conductors. These conductor bars 12 are connected to one another on the end face 13 facing away from FIG. 1 via a short-circuit ring. On the rear side 14 of the electric motor 10, the conductor bars 12 are individually fed by associated inverter modules. Since the electric motor 10 is operated at low voltages due to the conductor bars 12, the inverter modules, together with other electronic components (DC-DC converters, rectifiers), can be arranged relatively close together on printed circuit boards 15. In this example, the printed circuit boards 15 are ring-sector-shaped and many individual boards 15 together form a ring-shaped board structure. The rigid conductor bars can be formed from a metal bar, for example a copper bar, or from a solid multifilament conductor.

While it is assumed in the examples that the printed circuit boards 15 carry inverter modules, it is also possible that some of the printed circuit boards 15 carry rectifiers and DC/DC converters.

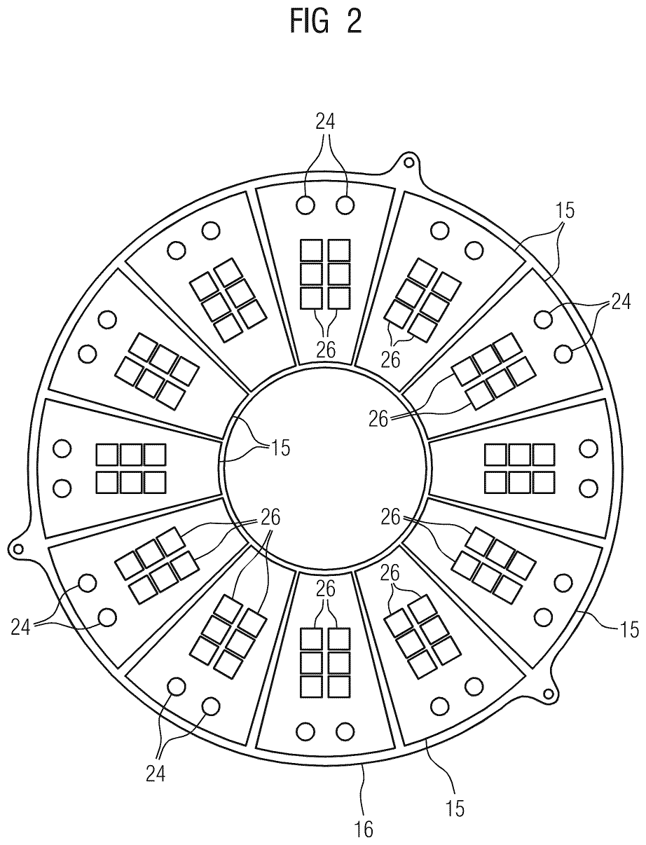

FIG. 2 shows a view of such a printed circuit board structure. The number of printed circuit boards shown in FIG. 2 is reduced and greatly simplified for a better overview compared to the representation in FIG. 1. The specific number of such printed circuit boards 15 depends on the specific design of the electric motor 10, in particular the number of conductor bars 12. Each of the printed circuit boards 15 comprises multiple power electronic components, in particular semiconductor switches 26.

Furthermore, some or all of the printed circuit boards 15 may comprise driver circuits and other electronic components such as capacitors that are not shown in the figures. The semiconductor switches 26 are power semiconductors such as IGBTs, MOSFETS or JFETs and may include additional diodes not shown depending on the circuitry. The semiconductor switches 26 are connected, for example, as half-bridges. A capacitor that is not shown can, for example, represent an intermediate circuit capacitor of the half-bridges. The semiconductor switches 26 of a printed circuit board 15 can be assigned to a single phase or to several phases.

The printed circuit boards 15 also include contact points 24 to which the conductor bars 12 are connected. The printed circuit boards 15 are supported by disc-shaped cooling plates 16, wherein the cooling plates 16 can be covered on both sides with printed circuit boards 15 to make better use of the space.

Since relatively high currents are necessary in the conductor bars of the electric motor 10 compared to conventional motors with windings, multiple inverters may be connected in parallel to supply them with current. This can be achieved, for example, by connecting the six printed circuit board structures shown in FIG. 1 on three cooling plates 16 all in the same way to the conductor bars 12, and thus connecting them electrically in parallel. This makes use of the fact that the conductor bars 12 or connecting elements 18 to the conductor bars 12 penetrate the cooling plates 16 and thus also the circuit boards 15 in the same way at the contact points or, in the case of the outermost cooling plate 16, at least make contact with them.

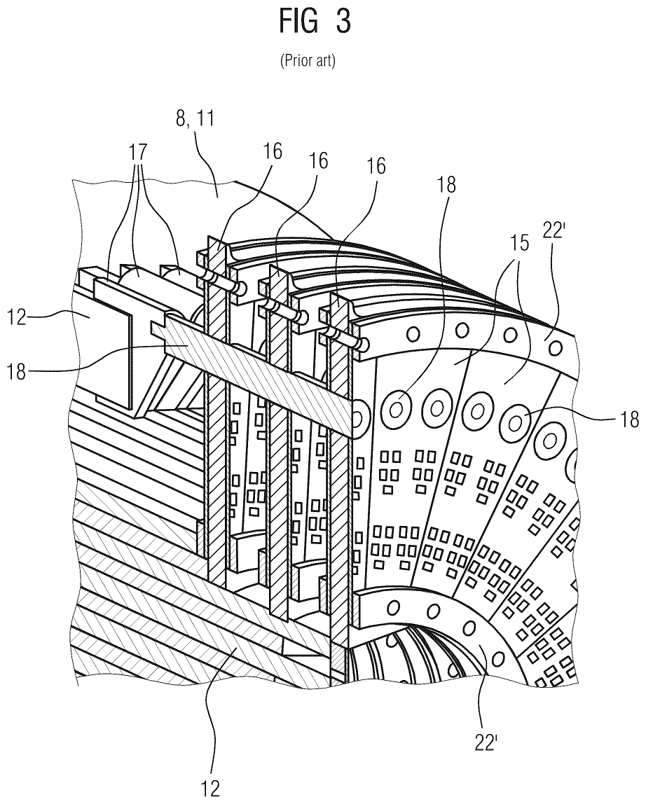

FIG. 3 shows a sectional view of the electric motor 10 in an oblique view. It can be seen that the connecting elements 18 mechanically support and penetrate the three cooling plates 16. The connecting elements 18 are connected to the conductor bars 12 via shoes 17. The inverters located on the printed circuit boards 15 in the areas where one of the connecting elements 18 penetrates a cooling plate 16 are connected in parallel and together provide the current for the conductor bar 12.

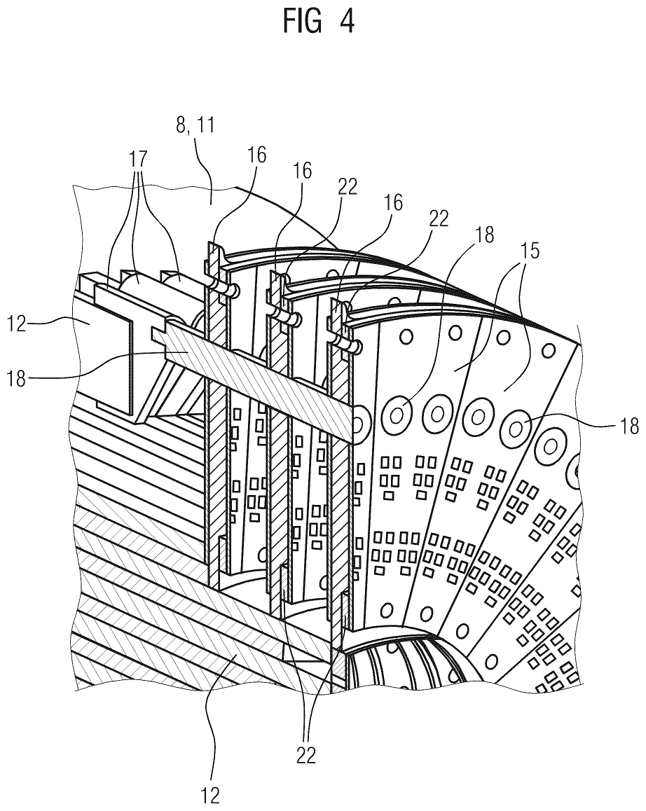

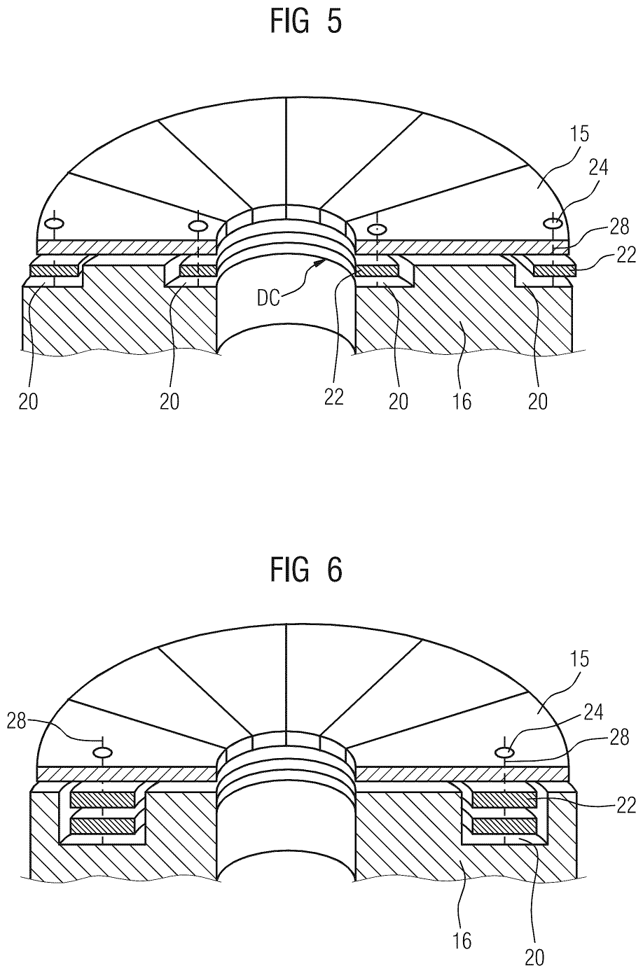

FIG. 3 also shows busbars 22′ in the design according to the prior art. These are screwed onto the printed circuit boards 15 and thus fasten them to the cooling plate 16. If a printed circuit board 15 is defective and needs to be replaced, the busbars 22 must be removed along with all the individual screw connections to the printed circuit boards 15. This means that, for example, for a hundred printed circuit boards 15 with three screw connections 28 each, three hundred screw connections 28 must be loosened. This effort is reduced by the design according to FIG. 4 and is subsequently shown in a schematized and enlarged form in FIGS. 5 to 8.

In FIG. 4, the same arrangement as in FIG. 3 is designed with respect to the busbars 22 in such a way that they are arranged below the printed circuit boards 15 in recesses 20 of the cooling plate 16. The overview in FIG. 4 illustrates the basic position of the busbars 22, which are shown schematically but enlarged in FIGS. 5-8.

FIG. 5 schematically shows a cross-section through a cooling plate 16 with printed circuit boards 15 mounted on it, as well as recesses 20 in which the busbars 22 are arranged. The contact is indicated in FIG. 5 by points 24. Accordingly, two recesses 20 are provided in FIG. 5, in which the busbars 22 run separately from one another. One recess 20 is arranged in a radially outer region of the cooling plate 16, and a second busbar 22 is arranged in a radially inner region of the cooling plate 16. The busbars 22 are separated from each other, and the contact is made at the respective outer ends of the printed circuit boards 15.

In FIG. 5, the busbar is completely covered by the printed circuit board 15. In some embodiments, the busbar 22 can extend beyond the cooling plate 16 at the edges and be only partially covered by the printed circuit board 15. In this case, the recess on an outer edge of the cooling plate would be open and flanked by the cooling plate on only one side. However, what is important, as is the case in all the FIGS. 4-8, is that the busbar 22 lies in a recess 20 between the printed circuit board 15 and the cooling plate 16 and can thus be removed and replaced by simply loosening the screw connection 28 of a printed circuit board 15. It is not necessary to unscrew the entire ring of the busbar 22 from all printed circuit boards 15 if only one printed circuit board 15 needs to be replaced. It should be noted that a screw connection 28 can be understood to mean any detachable connection with an electrical contact. A bolt designed accordingly can also be included under the term screw connection. However, a particularly technically favorable design for such a contact is the introduction of a metal screw.

In contrast to this, only one recess 20 is provided in the cooling plate 16, in which two busbars 22 are mounted one above the other, but electrically isolated from each other, according to FIG. 6. Here, too, contact is made by contact point 24, wherein the contact is made in each case insulated from each other with one of the busbars 22. The advantage of the structure according to FIG. 6 compared to that of FIG. 5 is that only one recess 20 is provided, thus providing more contact surface between the printed circuit board 15 and the surface of the cooling plate 16 for heat dissipation. However, in this structure according to FIG. 6, a greater effort is required to insulate the contact and the two busbars 22 from each other. The screw connection 28 is only indicated very schematically in FIGS. 5-7 by a dashed line.

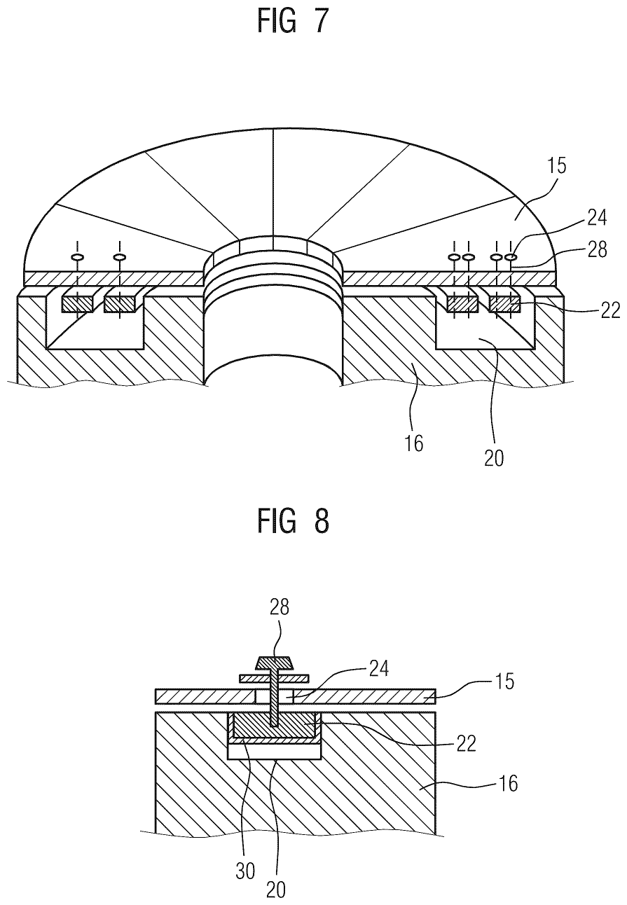

In the embodiment shown in FIG. 7, only one recess 20 is provided, which runs radially around a center point of the cooling plate 16. In this, however, two busbars 22 are arranged next to each other. In this case, only one recess 20 is necessary, but for positioning two busbars 22 next to each other, it is designed to be wider than the comparable recess 20 in FIG. 6.

FIG. 8 also shows schematically the contact between the busbar 22 and the printed circuit board 15. In this case, the screw connection 28 is guided through a contact point 24 that is at least partially electrically conductive, wherein this screw connection 28 is screwed into the busbar 22 so that an electric current can flow from the busbar 22 to the contact point 24 via the screw fitting 28. Furthermore, FIG. 8 also shows an insulation 30 that electrically insulates the busbar 22 from the cooling plate 16. This can be a flexible material, for example a silicone mat, which can also help to contain the busbars 22 in the recess 20 and to fix them there. The design according to FIG. 8 can also be used to utilize only one busbar 22 and to use the electrically conductive cooling plate 16 as a second current-carrying unit. The cooling plate 16 thus takes on the function of a second busbar 22. Contact can thus be made in a simpler manner and one busbar 22 is saved.

### REFERENCE CHARACTERS

8 Stator/rotor block
9 Motor axis
10 Electric motor
11 Stator
12 Busbars
13 End face
14 Rear face
15 Printed circuit boards
16 Cooling plate
17 Shoe
18 Connecting element
20 Recess
22 Busbar
24 Contact points
26 Semiconductor switch
28 Screw connection
30 Insulation

What is claimed is:

1-14. (canceled)

15. An electric motor comprising:
a stator with a plurality of field conductors;
a cooling plate;
a printed circuit board arranged on the cooling plate;
a plurality of power electronic components for controlling the field conductors, the power electronic components arranged on the printed circuit board;
wherein the cooling plate in is mechanical contact with the field conductors via current conductors electrically connected to the field conductors; and
a groove defining a recess in the cooling plate;
wherein a busbar is arranged in the recess and thereby electrically insulated from the cooling plate and at least partially covered by the printed circuit board; and
the printed circuit board is in electrical contact with the busbar.

16. The electric motor as claimed in claim 15, further comprising a second busbar arranged in the recess.

17. The electric motor as claimed in claim 16, wherein the two busbars are arranged next to each other in the recess radially with respect to a motor axis.

18. The electric motor as claimed in claim 16, wherein the two busbars are arranged one above the other in the recess along a motor axis.

19. The electric motor as claimed in claim 15, further comprising a second recess and a second busbar disposed in the second recess.

20. The electric motor as claimed in claim 15, wherein the cooling plate comprises a second busbar.

21. The electric motor as claimed in claim 15, wherein the cooling plate is ring-shaped.

22. The electric motor as claimed in claim 15, wherein the busbar is ring-shaped.

23. The electric motor as claimed in claim 15, wherein the busbar is clamped in the recess by an insulating flexible material.

24. The electric motor as claimed in claim 15, wherein the printed circuit board is electrically contacted with the busbar by a screw connection.

25. The electric motor as claimed in claim 15, wherein the printed circuit board has a shape of a circle or a ring sector.

26. The electric motor as claimed in claim 15, wherein the cooling plate is arranged perpendicular with respect to an axis of the electric motor.

27. The electric motor as claimed in claim 15, wherein each field conductor has a dedicated phase.

28. The electric motor as claimed in claim 15, wherein the inverters generate an alternating voltage with an amplitude of 200 V or less.
